(19) United States
(12) Patent Application Publication
(10) Pub. No.: US 2007/0269736 A1
(43) Pub. Date: Nov. 22, 2007

(54) NEW SUB 40 NM RESOLUTION Si CONTAINING RESIST SYSTEM

(75) Inventors: James P. Bucchignano, Yorktown Heights, NY (US); Wu-Song S. Huang, Poughkeepsie, NY (US); Lidija Sekaric, Mount Kisco, NY (US); Raman G. Viswanathan, Briarcliff Manor, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/383,548

(22) Filed: May 16, 2006

(51) Int. Cl. G03C 1/00

(52) U.S. Cl. 430/270.1

(57) ABSTRACT

The present invention discloses a resist composition and a method of forming a material structure having a pattern containing features having a dimension of about 40 nm or less by using the inventive resist. The inventive resist comprises a polymer and a photoacid generator. The polymer of the present invention comprises pendant polar moieties, pendant fluoroalcohol moieties, and a backbone containing SiO moieties. In the present invention, at least a portion of the polar moieties are protected with acid labile moieties having a low activation energy. It is preferred that some, but not all, of the pendant fluoroalcohol moieties are protected with acid labile moieties having a low activation energy.

### FIELD OF THE INVENTION

This invention relates to a resist composition for printing features having a dimension of about 40 nm or less and a method of forming a material structure having a pattern containing features having a dimension of about 40 nm or less on a substrate by using the inventive resist composition in lithography.

### BACKGROUND OF THE INVENTION

The microelectronics industry strives toward fabricating high density circuitry by decreasing the minimum feature size of the components on the chip. To facilitate the increase in device density, new technologies are constantly needed to allow the minimum feature size of these semiconductor devices to be reduced. This requires high-resolution lithography, the principal technique used in patterning microelectronics circuitry. Over approximately the last 20 years, the industry has migrated to shorter wavelength photolithography as the primary means of scaling the resolution to sustain the progressive demand for smaller features. The wavelength of photolithography has migrated from mid-ultraviolet (MUV) wavelengths (350-450 nm) to deep-UV (DUV) radiation (190-300 nm) and vacuum UV (VUV, 125-160 nm). Likewise the photosensitive materials used in photolithography, known as resists, have evolved. MUV lithography employed diazonaphthoquinone (DNQ) and novolac-based resists. These materials offered high performance but were not extendible to DUV and VUV wavelengths due to their opacity at these shorter wavelengths. In addition, these resists were not of sufficient sensitivity to afford high throughput manufacturing.

In response to the need for new, lower opacity, higher sensitivity materials for DUV imaging, Ito et al. disclosed in U.S. Pat. No. 4,491,628 the development of chemically amplified (CA) resists based on photochemically-generated-acid catalyzed deprotection of an acid labile polymer. That is, for positive tone CA resists, acid labile moieties of the polymer are cleaved by an acid catalyzed thermolysis reaction that renders the deprotected form of the polymer soluble in a subsequently applied developer, such as an aqueous base. Thus, an image of the projected patternwise radiation is formed in the resist film after development, which can then serve as an etch-resistant mask for a subsequent pattern transfer step. The resolution obtained is dependent on the quality of aerial image and the ability of the resist to maintain that image. CA resists have been developed for 248, 193, and 157 nm lithography.

An image of the projected patternwise radiation is formed in the resist film after development, which can then serve as an etch-resistant mask for subsequent pattern transfer steps. The resolution obtained is dependent on the quality of the aerial image and the ability of the resist to maintain that image.

The resolution, R, of an optical projection system such as a lithography stepper is limited by parameters described in Raleigh's equation:

R=kλ/NA,

where λ represents the wavelength of the light source used in the projection system and NA represents the numerical aperture of the projection optics used. “k” represents a factor describing how well a combined lithography system can utilize the theoretical resolution limit in practice and can range from about 0.85 down to about 0.35 for standard exposure systems. The theoretical dimensional limit of equal-sized half-pitch features is one quarter of the wavelength, λ (k=0.25) when NA=1, and thus the resolution cannot be modulated by any more than λ4, or a pitch of λ/2. The resolution attainable with each advancing generation of materials has been extended toward these limits through the use of low k techniques and high numerical aperture tools. For 157 nm lithography, the latest VUV wavelength being developed for manufacturing, and using a very high but potentially manufacturable NA of 0.95, the minimum k factor (i.e. λ/4) equals approximately 40 nm. To obtain images below this feature size, either an extension of NA to>1, such as is afforded with immersion lithography, or with a non-diffraction limited, non-optical lithography system, such as the so-called next generation lithography (NGL), are options. The most promising of these NGLs are extreme ultraviolet (EUV, sometimes referred to as soft x-ray) or electron beam lithography (EBL).

As the desired feature size decreases, the resolution capability of many current resists is not sufficient to yield the smaller features. The need to achieve less than 100 nm resolution has prompted a push toward increasing numerical aperture (NA) exposure tools. The higher NA allows for improved resolution of smaller feature sizes, however, the higher NA also reduces the depth of focus of aerial images projected onto the resist film. When the depth of focus is relatively shallow, the thickness of the resist film becomes a factor in achieving proper exposure. Thus, thinner resist films may be required for proper exposure at high resolution, but such films often do not yield acceptable overall performance, especially when considering etch requirements for the underlying substrate.

As the resist film is thinned to account for the higher NA, the resist becomes less suitable as an etch mask against later processing of the underlying semiconductor substrate. For example, since the resist film is thin, variation in thickness becomes more significant and may introduce defects into subsequent devices formed on the substrate. Also, micro-channels often form in the upper portions of a resist layer during transfer of the resist image to the substrate by etching. When the resist layer is thin, the micro-channels may extend to the underlying substrate, rendering the resist less effective as a mask.

In addition, the process latitude of many current resists is not sufficient to consistently produce the smaller desired features within specified tolerances. Some of the process parameters where variance may be difficult to avoid include bake time and temperature, exposure time and source output, aerial image focus, and develop time and temperature. The process latitude of a resist is an indication of how wide such variations can be without resulting in a change in the resolution and/or image profile (i.e., size and/or shape of a resist image). That is, if the process latitude is sufficiently wide, then a process parameter may vary, but the variance will not produce a change in the resist image incompatible with specified tolerances.

Another problem that occurs as feature size decreases and pattern density increases is that collapsing of such high aspect ratio features in the resist may occur. Thus, a thinner resist layer may be required to minimize image collapse.

One approach that enables the use of higher NA exposure tools as well as a thinner photoresist film is multilayer resist processing. One type of multilayer resist processing uses a bilayer (two layer) imaging scheme by first casting a highly energy absorbing underlayer on the semiconductor substrate then casting a thin, silicon-containing imaging layer (photoresist film) on top of the underlayer. The silicon-containing resist provides good etch selectivity for anisotropic dry etch processing, such as reactive ion etch (RIE) using an oxygen-containing plasma. Next, selected portions of the silicon-containing layer are exposed and developed to remove the unexposed portions of a negative photoresist film or the exposed portions of a positive photoresist film. Generally, the underlayer is highly absorbing at the imaging wavelength and is compatible with the imaging layer. Also, the refractive index of the underlayer is matched to the refractive index of the silicon-containing resist layer to avoid degrading the resolution capability of the silicon-containing resist.

Conventional underlayers include diazonapthoquinone (DNQ)/novolac resist material or novolac resin cast on the semiconductor substrate. The underlayers are typically selected to have good selectivity for an anisotropic etch, and to be sufficiently rigid to minimize feature collapse.

For the imaging layer, resists containing a wide variety of silicon-containing polymers have been used, including silsesquioxane, silicon-containing acrylics, silanes, etc. Among the several possible silicon-containing polymers, aqueous base-soluble silsesquioxane polymers, such as poly (p-hydroxybenzylsilsesquioxane) (PHBS), have emerged as the most promising candidates for silicon-containing polymers in bilayer resist systems. Unfortunately, although promising, phenolic polymers, such as PHBS, have transparency limitations. The phenolic polymers used in 365 nm and 248 nm wavelength lithographic processes do not provide sufficient transparency for 193 nm and 157 nm lithographic processes to produce vertical profiles on the resist images. For example, prior art phenolic polymers have extremely high absorption in the range of 10 μm⁻¹ at 193 nm.

One barrier to imaging in the sub-50 nm half-pitch regime is a phenomenon known as image blur, which diminishes the integrity of the pattern (see, for example, Hinsberg et al., Proc. SPIE, 2000, 3999, 148 and Houle et al., J. Vac. Sci. Technol B, 2000, 18, 1874). Image blur can be defined as the deviation of the developable image from that of projected aerial image which is transferred into the film as the concentration of photochemically generated acid. While accelerating the rate of the deprotection reaction, the application of thermal energy diminishes the fidelity of the aerial image of acid formed during the patternwise exposure. Image blur can be divided into two contributing factors: gradient-driven acid diffusion and reaction propagation. Both factors contribute to blur, but to different degrees and with different temperature dependence.

The first factor contributing to image blur is often referred to as acid diffusion and can be described by Fickian diffusion models for solids (Hinsberg, 2000). Choice of the photoacid being generated from the photoacid generator (PAG) and the mobility in the chosen polymer matrix dictate this factor. The mobility in the polymer matrix is dependent on the comprising chemical functionality of the polymer, the free volume of the matrix, the glass transition temperature (T_{g}) of the polymer and the temperature and time of baking steps encountered during the resist processing. Processing at temperatures above T_{g} will tend to increase image blur. Therefore, a higher T_{g} is often desired to avoid blur-inducing film instability. Higher T_{g} is typically achieved by providing longer cyclic chains in the side groups. However, longer cyclic chains tend to decrease the transparency of the resist formulation at the wavelengths of interest.

A second contributing factor to image blur is sometimes described as reaction propagation (Hinsberg, 2000; Houle, 2000) and is best described by Arhenius behavior. Activation energy (enthalpy, hereinafter referred to as Eₐ), volatility of products (entropy), and the availability and concentration of deprotection-reaction-dependent co-reactants such as moisture dictate the degree to which the reaction propagates away from the original acid profile. Higher Eₐ for the deprotection reaction requires higher baking temperatures, which will tend to increase image blur. Current resists for 193 nm lithography have relatively high Eₐ (i.e. greater than about 20 kcal/mol).

In order to achieve high resolution, high sensitivity and high degree of process latitude, both image blur factors must be eliminated or minimized. Both of these contributing factors can be tempered by the addition of acid-quenchers, or bases, which have been shown to reduce image blur. Additionally it has been recognized that image blur is temperature dependent, and tends to increase as processing temperature increases. Breyta et al. disclosed in U.S. Pat. No. 6,227,546 that appropriate baking conditions can optimize the resolution attainable with CA resists. However, since the image blur resulting from diffusion of photochemically generated acid has been determined to be on the order of 10-50 nm and is enhanced by post-exposure baking (PEB), it is extremely difficult to create dense (1:1) device features around 50 nm or less using conventional CA resists. One approach to resolve this acid diffusion problem is to use CA resists having low activation energy, such as ketal resist system (“KRS”). However, the original KRS resists are based on polyvinylphenols, which do not have sufficient etch resistance for thin film with thickness in the 30-40 nm range. Silsesquioxane (SSQ) polymers containing phenolic structures have been used for E-beam resist application. However, it is very difficult in controlling the SSQ polymer dissolution properties to obtain high resolution images in 30 nm l/s range.

Thus, there remains a need for a high resolution resist composition having desirable etch resistance, dissolution characteristic, as well as optical properties for sub 40 nm dense feature resolutions and a method of performing sub 40 nm imaging.

### SUMMARY OF THE INVENTION

Accordingly, the present invention provides a resist composition comprising a polymer and a photoacid generator. The polymer of the present invention comprises pendant polar moieties, pendant fluoroalcohol moieties, and a backbone containing SiO moieties. In the present invention, at least a portion of said pendant polar moieties are protected with acid labile moieties having a low activation energy. It is preferred that some, but not all, of the pendant fluoroalcohol moieties are protected with acid labile moieties having a low activation energy.

The present invention also provides a method of forming a patterned structure on a substrate, said method comprising: applying the inventive resist composition to a substrate to form a resist layer on the substrate; patternwise exposing the resist layer to an imaging radiation; developing a patterned resist structure in the exposed resist layer; and transferring the pattern in the patterned resist structure to the substrate.

### DETAILED DESCRIPTION OF THE INVENTION

The present invention is directed to a resist composition for printing features having a dimension of about 40 nm or less. The inventive resist composition comprises a polymer and a photoacid generator. The polymer of the present invention comprises pendant polar moieties, pendant fluoroalcohol moieties, and a backbone containing SiO moieties. In the present invention, at least a portion of said pendant polar moieties are protected with acid labile moieties having a low activation energy. By “acid labile moiety”, it is meant any chemical moiety that readily undergoes a deprotection reaction in the presence of acids. By “activation energy”, it is meant the threshold energy or the energy that must be overcome in order for a chemical reaction (e.g., deprotection reaction) to occur. The term “low activation energy” as used herein denotes an activation energy having an Ea of about 20 kcal/mol. or less. It is preferred that some, but not all, of the pendant fluoroalcohol moieties are protected with acid labile moieties having a low activation energy. The backbone containing SiO moieties may be a linear, branched, or caged structure or any combinations thereof having a ratio of O to Si ranging from about 1.0 to about 1.9. The backbone containing SiO moieties may further comprise C or other elements. When the backbone containing SiO moieties further comprises C or other elements, the ratio of O to Si may be less than 1.0. Examples of the backbone containing SiO moieties include, for example, silane, siloxane, and silsesquioxane. It is preferred that the backbone containing SiO moieties is a silsesquioxane backbone. By “silsesquioxane”, it is meant an organosiloxane polymer, linear or caged, that includes a moiety having the following structure:

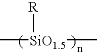

wherein R is an organic moiety, and n is an integer of 1 or above.

The term “pendant polar moieties” as used herein denotes polar moieties pendant from the polymer backbone. By “polar moieties”, it is meant any chemical group in which the distribution of electrons is uneven enabling it to take part in electrostatic interactions. The pendant polar moieties suitable for the present invention include, but are not limited to: hydroxyl and carboxlate groups. It is preferred that the pendant polar moieties comprise phenolic groups. The term “phenolic group” as used herein denotes an organic radical pertaining to, or derived from, phenol. The pendant polar moieties impart high reactivity and hydrophillicity to the inventive polymer thereby increasing the dry etching rate of the inventive resist and promoting solubility of the inventive resist in aqueous alkaline solutions.

The term “pendant fluoroalcohol moieties” as used herein denotes fluoroalcohol moieties pendant from the polymer backbone. By “fluoroalcohol”, it is meant an alcohol wherein some or all of hydrogen atoms on the carbon backbone are substituted by fluorine atoms. It is preferred that each of the pendant fluoroalcohol moieties comprises the following structure:

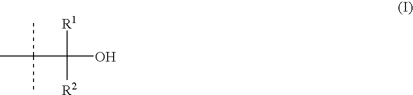

wherein R¹ is hydrogen or a semi- or per-fluorinated alkyl group having 1 to 6 carbon atoms; and R² is a semi- or per-fluorinated alkyl group having 1 to 6 carbon atoms. By “perfluorinated”, it is meant all hydrogen atoms on the carbon backbone of an organic radical are substituted by fluorine atoms. By “semifluorinated”, it is meant a portion of hydrogen atoms on the carbon backbone of an organic compound are substituted by fluorine atoms. It is preferred that R¹ is hydrogen, trifluoromethyl, difluoromethyl, or fluoromethyl; and R² is trifluoromethyl, difluoromethyl, or fluoromethyl. Examples of the pendant fluoroalcohols moieties suitable for the present invention include, but are not limited to: hexafluoroisopropanol, trifluoroisopropanol, and trifluoroethanol. It should be understood by one skilled in the art that the pendant fluoroalcohol moieties of formula (I) of the present invention is covalently bonded to the polymer backbone through the bond crossed by a dotted line. The pendant fluoroalcohol moieties impart etch resistance and hydrophobicity to the inventive polymer thereby decreasing the dry etching rate of the inventive resist and reducing the dissolution rate of the inventive resist in aqueous alkaline solutions.

The acid labile moieties suitable for the present invention may be any acid labile moiety having a low activation energy. Preferred acid labile moieties having the low activation energy of the present invention include, but are not limited to: acetals, ketals, and orthoesters. More preferred acid labile moieties having the low activation energy are ketal moieties. The most preferred acid labile moieties having the low activation energy are aliphatic ketals having 4 to 40 carbon atoms. The aliphatic ketals suitable for the present invention may contain straight, branched, or cyclic alkyl groups. Examples of non-cyclic aliphatic ketals include, but are not limited to: methoxy propyl, methoxy butyl, and methoxy pentyl. Examples of cyclic aliphatic ketals include, but are not limited to: methoxycyclopropanyl, ethoxycyclopropanyl, butoxycyclohexanyl, methoxycyclobutanyl, ethoxycyclobutanyl, methoxycyclopentanyl, ethoxycyclopentanyl, methoxycyclohexanyl, ethoxycyclohexanyl, propoxycyclohexanyl, methoxycycloheptanyl, methoxycyclooctanyl and methoxyadamantyl. In a preferred embodiment of the present invention, the acid labile moieties having a low activation energy are cyclic aliphatic ketals. Prior to exposure to light radiation, the acid labile moieties of the inventive polymer inhibit solubility of the inventive resist in aqueous alkaline solutions. Upon exposure to light radiation, the acid labile moieties of the inventive polymer are cleaved by an acid catalyzed thermolysis reaction that renders the deprotected form of the inventive polymer soluble in a subsequently applied aqueous alkaline developer.

It is preferred that about 10 to about 100 mol % of the pendant polar moieties in the inventive polymer are replaced with acid labile moieties having a low activation energy. It is more preferred that about 15 to about 80 mol % of the pendant polar moieties in the inventive polymer are replaced with the acid labile moieties having the low activation energy.

It is also preferred that about 1 to about 99 mol % of the pendant fluoroalcohol moieties in the inventive polymer are replaced with acid labile moieties having a low activation energy. It is more preferred that about 1 to about 50 mol % of the pendant fluoroalcohol moieties in the inventive polymer are replaced with the acid labile moieties having the low activation energy.

In the present invention, the acid labile moieties having a low activation energy on the pendant polar moieties may be identical with or different from the acid labile moieties having a low activation energy on the pendant fluoroalcohol moieties. The acid labile moieties having a low activation energy are preferably cleavable in the presence of an acid at a temperature of about 110° C. or less so that image blur is minimized or avoided. The lability of the acid labile moieties is preferably dependent on the presence of a co-reactant which enables and/or facilitates the cleaving of the acid labile group in the presence of a generated acid. The co-reactant is preferably water or an alcohol, more preferably water. The co-reactant may be present in the resist layer prior to imaging and/or may be introduced during, or after, imaging. Preferably, the co-reactant is not present in the resist prior to exposure to imaging radiation.

The properties of the inventive polymer, particularly dissolution characteristics and the etch resistance thereof, may be adjusted by varying the molar ratio of the pendant polar moieties to the pendant fluoroalcohol moieties. Depending on the intended use and desired performance, the pendant polar moieties and the pendant fluoroalcohol moieties of the present invention may be in a molar ratio from about 9:1 to about 1:9, with a molar ratio in the range from about 3:17 to about 10:10 more preferred. It should be understood that the molar ratio of the pendant polar moieties to the pendant fluoroalcohol moieties, as recited herein, denotes the molar ratio of all the pendant polar moieties, including the pendant polar moieties protected with acid labile moieties having a low activation energy, to all the pendant fluoroalcohol moieties, including the pendant polar fluoroalcohol moieties protected with acid labile moieties having a low activation energy.

In one embodiment of the present invention, the polymer comprises a combination of monomer units having the following structures:

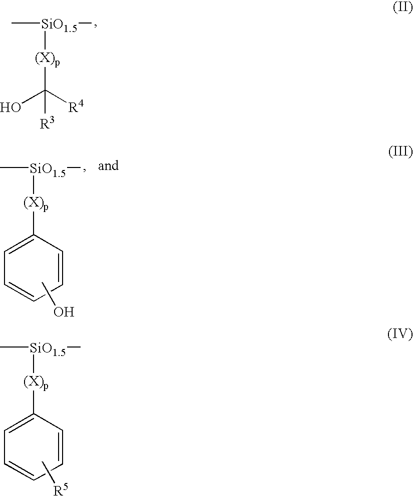

wherein X is a linear or branched alkylene group having 1 to 6 carbon atoms; p is an integer of 0 or 1; R³ is hydrogen, or a semi- or per-fluorinated alkyl group having 1 to 6 carbon atoms; R⁴ is a semi- or per-fluorinated alkyl group having 1 to 6 carbon atoms; and R⁵ is a cyclic aliphatic ketal.

In another embodiment of the present invention, the polymer containing a combination of monomer units having the structures of formula (II), formula (III) and formula (IV) further comprises a monomer unit having the following structure:

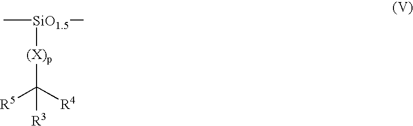

wherein X is a linear or branched alkylene group having 1 to 6 carbon atoms; p is an integer of 0 or 1; R³ is hydrogen, or a semi- or per-fluorinated alkyl group having 1 to 6 carbon atoms; R⁴ is a semi- or per-fluorinated alkyl group having 1 to 6 carbon atoms; and R⁵ is a cyclic aliphatic ketal.

In another embodiment of the present invention, the polymer comprises the following structure:

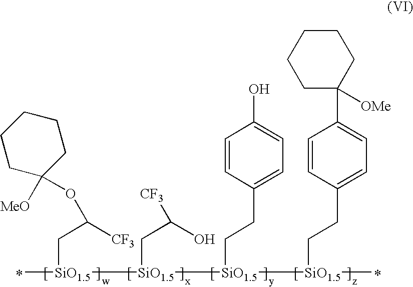

wherein w, x, y, and z are the same or different, and are integers of 5 to 500. Preferably, w, x, y, and z are in a ratio of about 3:67:15:15.

It is also preferable that the inventive polymer has a tunable polymer molecular weight with average molecular weight ranging from about 1K to about 500K Daltons to enable the formulation of high solid content spin castable solutions with adequate viscosity. More preferably, the weight average molecular weight of the inventive copolymer ranges from about 1K to about 200K Daltons. Additional co-monomers can also be added to prepare copolymer materials with improved mechanical durability and/or to adjust the optical property of the inventive polymer.

A “photoacid generator”, also known as PAG, is a compound that generates an acid molecule upon illumination. PAGs suitable for the the present invention may be any photosensitive acid generator that is known in the resist art and compatible with other selected components of the inventive resist composition. Examples of PAGs suitable for the present invention include, but are not limited to: sulfones, sulfonates, carboxylates, onium salts, and combinations thereof. The PAGs used in the present invention may be one type of PAG or a combination of different types of PAGs.

In the present invention, it is preferred that the photoacid generator is an onium salt. The onium salts suitable for the present invention include, but are not limited to: iodonium salts, sulfonium salts, or a mixture thereof. It is more preferred that the photoacid generators are sulfonium or iodnium sulfonates, the anions of which are partially or totally substituted with fluorine atoms. In one embodiment of the present invention, the partially fluorine substituted anion of the photoacid generator comprises the following structure:

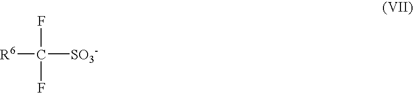

wherein R⁶ is an aromatic moiety, aliphatic moiety, alicyclic moiety, or a combination thereof. As used herein, the term “aliphatic moiety” denotes a hydrocarbon radical having carbon atoms linked in open chains; and the term “alicyclic moiety” denotes a hydrocarbon radical having carbon atoms linked in cyclic structures. The aliphatic moieties suitable for the present invention may be straight or branched, and include, but are not limited to: alkyl, alkenyl, and alkynyl. The alicyclic moieties suitable for the present invention include, but are not limited to: cyclobutyl, cyclopentyl, cyclohexyl, cycloheptyl, cyclooctyl, norbomyl, and adamantyl. The term “aromatic moiety” is defined as described above. The term “an aromatic moiety” as used herein denotes an organic compound characterized by increased chemical stability resulting from the delocalization of electrons in one or more rings which typically contain multiple conjugated double bonds. The aromatic moiety of the present invention may be carbocyclic or heterocyclic. By “carbocyclic aromatic moiety”, it is meant an aromatic moiety containing only hydrogen atoms and carbon atoms. By “heterocyclic aromatic moiety”, it is meant an aromatic moiety containing one or more heteroatoms selected from nitrogen, oxygen, sulfur, or a combination thereof in the aromatic ring(s). The aromatic moiety may be monocyclic or polycyclic. The rings in the polycyclic aromatic moiety may be fused or non-fused. The aromatic moieties suitable for the present invention include, but are not limited to: phenyl, tolyl, xylyl, naphthyl, and pyridyl.

It is more preferred that the photoacid generators are strong acids with fluorinated substituents, such as, for example, triaryl sulfonium perfluoroalkylsulfonates. The term “aryl” as used herein denotes an organic radical derived from an aromatic moiety by the removal of one hydrogen atom. The term “aromatic moiety” is defined as described above. The term “perfluoroakyl” is defined as described above. Perfluoroalkyl suitable for the present invention may be straight, branched, or cyclic perfluoroalkyl having 1 to 6 carbon atoms. Examples of triaryl sulfonium perfluoroalkylsulfonate suitable for the present invention include, but are not limited to: triphenylsulfonium triflate, triphenylsulfonium nonaflate, tris (t-butylphenyl) sulfonium triflate, t-butylphenyl diphenylsulfonium triflate, t-butylphenyl diphenylsulfonium nonaflate, t-butylphenyl diphenylsulfonium, perfluorooctanesulfonate, and similar derivatives and analogs thereof.

In one embodiment of the present invention, the PAGs are compounds comprising the following structure:

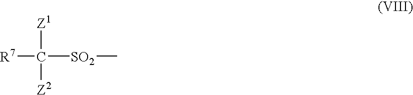

wherein R⁷ is a monovalent organic group with a fluorine content of 50 weight % or less, a nitro group, a cyano group, or a hydrogen atom; and Z¹ and Z² are the same or different, are independently a fluorine atom, or a straight or branched perfluoroalkyl group having 1 to 10 carbon atoms. The term “perfluoroalkyl” is defined as described above. Examples of perfluoroalkyl suitable for the present invention include those described in U.S. Patent Application Publication No. 2003/0113658 A1, the disclosure of which is herein incorporated by reference.

It is also more preferred that the photoacid generators are strong acids without fluorinated substituents, such as, for example, a triaryl sulfonium sulfonate having an anion comprising one of the following structures:

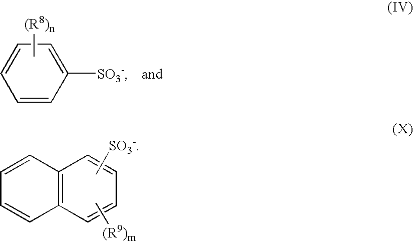

wherein R⁸ and R⁹ are the same or different, and are independently a nitro group, a cyano group, or a mixture thereof, n is an integer of 1 to 5; and m is an integer of 1 to 7.

Other examples of PAGs suitable for the present invention include, but are not limited to: (trifluoromethylsulfonyloxy)-bicyclo[2.2.1]hept-5-ene-2,3-dicarboximide (“MDT”) and sulfonic acid esters of N-hydroxy-amides or imides, as described in U.S. Pat. No. 4,731,605, the disclosure of which is incorporated by reference herein. The PAGs suitable for the present invention also include PAGs that produce weaker acids, such as, for example, dodecane sulfonate of N-hydroxy-naphthalimide (“DDSN”).

The inventive resist composition may further comprise at least one base additive. The base additive suitable for the present invention may be any basic organic compound which can quench an acid and limit the extent of image blur. In the present invention, a preferred base additive is a tetra-alkylammonium hydroxide. Suitable alkyl groups in the tetra-alkylammonium hydroxide may be a straight, branched, or cyclic alkyl group having 1 to 6 carbon atoms. Examples of the tetra-alkylammonium hydroxide include, but are not limited to: tetra-ethylammonium hydroxide, tetra-propylammonium hydroxide, and tetra-butylammonium hydroxide.

It is most preferred that PAGs used for the present invention are compounds which generate very strong acids upon exposure to imaging radiation so that the deprotection reactions of the acid labile moieties having a low activation energy are quickly initiated, and base additives used for the present invention are very strong bases which can effectively quench the excessive photochemically generated acids. The PAG load, i.e., the weight % of the PAG, in the inventive resist composition is higher than that in the prior art resist, thus more acids are generated upon imaging radiation. The base additive load, i.e., the weight % of the base additive, in the inventive resist composition is also higher than that in the prior art resist so that deprotection range of the acid labile moieties is reduced.

The inventive resist composition may further comprise at least one surfactant. The surfactants that can be employed in the invention are those that are capable of improving the coating homogeneity of the inventive antireflective coating composition. Illustrative examples of such surfactants include, but are not limited to: fluorine-containing surfactants such as 3M's FC-430®, FC-4430® and the like, siloxane-containing surfactants such as Union Carbide's SILWET® series and the like, or a mixture thereof.

It is preferred that the inventive resist composition may contain about 10 to about 500 ppm of the at least one surfactant, based on the total weight of the polymer. More preferably, the inventive resist composition may contain about 50 to about 300 ppm of the at least one surfactant, based on the total weight of the polymer.

In another aspect of the invention, the inventive resist composition may be used in a method of forming a patterned substrate. The patterned substrate contains features having a dimension of about 40 nm or less. The inventive method comprises:

applying the inventive resist composition to a substrate to form a resist layer on the substrate;

patternwise exposing the resist layer to an imaging radiation;

developing a patterned resist structure in the exposed resist layer; and

transferring the pattern in the patterned resist structure to the substrate.

The substrate may be any desired substrate such as a semiconductor wafer, a mask blank, and the like. The substrate is preferably a silicon semiconductor wafer. The substrate may or may not have additional layers of materials already deposited on it, including patterned or unpatterned layers containing multiple materials which may be in the form of device features, wires, and the like. The material layer is preferably selected from the group consisting of organic dielectrics, metals, ceramics, and semiconductors. The material layer may be formed by any conventional technique (e.g., by implanting, spin-coating, CVD, PVD, etc.). The invention is not limited to any specific substrate, material layer or method of providing such material layer.

The inventive resist is typically cast from an appropriate solvent. Preferred solvents are propylene glycol monomethyl ether acetate (PGMEA), ethyl lactate, 4-methyl-2-pentanol, cyclohexnone, or a mixture thereof.

The resist layer is preferably formed on the substrate by spin coating, slot coating or by other methods known to those skilled in the art. The coating thickness is preferably appropriate for the target feature size taking into consideration of the numerical aperture or resolution capability of the imaging device, the material layer to be patterned, and other relevant factors. The inventive resist composition is typically applied onto a surface of a suitable substrate by coating applications well known to those skilled in art so that a thin film resist having a thickness from about 0.02 to about 10 μm is achieved.

In one embodiment of the present invention, prior to applying the inventive resist composition to the substrate to form the resist layer, a planarizing layer is formed over the substrate, and then the resist layer is applied to the planarizing layer so that the planarizing layer is on top of and in direct contact with the resist layer.

After applying the resist, the resist layer is preferably baked mildly to remove the casting solvent (also known as post-application bake or PAB). The baking temperature is preferably such that the majority or all of the solvent is dispelled form the resist without causing thermally-induced deprotection or decomposition of resist components. A preferred baking temperature is from about 800 to about 120° C., more preferably about 900 to about 110° C. The post-application bake step is preferably conducted for about 10 seconds to about 15 minutes, more preferably about 15 seconds to about one minute.

The resist layer is then exposed to an imaging radiation in a pattern corresponding to a desired structure (to be created by pattern transfer to the underlying material layer) having features having a dimension of about 40 nm or less. The exposure radiation is preferably selected from the group consisting of EUV radiation (13.4 nm), electron beams (EB), ion beams (IB), x-rays (1.4 nm, 1.1 nm), VUV (using extremely low K₁ factor (about 0.25) and NA>1), or DUV (using extremely low K₁ factor (about 0.25) and NA>1). During radiation exposure of the resist layer, acid is generated by the photoacid generator in exposed regions of the resist layer. Thus, the exposure causes formation of a corresponding pattern of latent acid in the resist layer.

The exposure step is preferably conducted in the substantial absence of deprotection-reaction-dependent co-reactants (or at least in the absence of such co-reactants in the environment surrounding the resist layer in the imaging tool). In embodiments where the resist used is a KRS-type resist, a co-reactant for deprotection reaction propagation is water. By “KRS”, it is meant ketal resist system. Thus, the exposure environment preferably has a relative humidity (RH) less than about 10%, more preferably less than about 1%, most preferably less than about 0.1%. EUV, EB, IB and x-ray exposure tools typically provide a moisture-free environment by providing high vacuum during the exposure. Optical radiation exposure tools can achieve a substantially anhydrous environment by use of vacuum or rigorous purging with a dry, inert gas such as nitrogen, helium or argon.

After the radiation exposure, a post-exposure environment containing one or more deprotection-reaction-dependent co-reactants is provided for the substrate. The environment preferably contains sufficient concentration of the deprotection-reaction-dependent co-reactant and has a temperature suitably low enough to prevent significant image blur, but not so low as to stop the deprotection reaction entirely. Where water is the co-reactant, the environment preferably has a relative humidity of about 10% to about 80%, more preferably about 30% to about 60%, most preferably about 35% to about 50%. The temperature of the environment is preferably selected in combination with the concentration of co-reactant to provide a post-exposure treatment time on the order of about 30 seconds to about 45 minutes, more preferably about 1 to about 30 minutes, most preferably about 1 to about 5 minutes. The post-exposure environment temperature is preferably about 10° to about 110° C., more preferably about 15° to about 60° C., most preferably about 20° to about 50° C. The exposed resist layer is treated with a deprotection reaction-dependent co-reactant for a time sufficient to promote acid-catalyzed reaction in exposed portions of the resist layer but not so long as to cause resolution degradation due to acid diffusion-induced blur.

After the post-exposure treatment as described above, a patterned resist structure is then developed by contacting the resist with an aqueous alkaline developer or other known developing agent; thereby the exposed portions of the exposed resist layer are removed. A preferred developer is an aqueous solution of tetramethyl ammonium hydroxide (TMAH). A preferred concentration of the aqueous TMAH solution is about 0.1 to 0.4 N (normal), more preferably about 0.2 to 0.3 N. If desired, surfactants or other additives may be employed in the developer solution, e.g., to aid in salvation and/or to prevent image collapse.

The pattern from the resist structure may then be transferred to the underlying substrate (e.g., organic dielectric, ceramic, metal or semiconductor). Typically, the transfer is achieved by dry etching (e.g., reactive ion etching, plasma etching, ion beam, etc.), wet etching, or some other suitable technique. The methods of the invention can be used to create patterned material layer structures such as metal wiring lines, holes for contacts or vias, insulation sections (e.g., damascene trenches or shallow trench isolation), trenches for capacitor structures, gate stacks, etc. as might be used in the design of integrated circuit devices. In some instances, a hard mask may be used below the resist layer to facilitate transfer of the pattern to a further underlying material layer or section. Examples of pattern transfer are disclosed in U.S. Pat. Nos. 4,855,017; 5,362,663; 5,429,710; 5,562,801; 5,618,751; 5,744,376; 5,801,094; and 5,821,469, the disclosures of which patents are incorporated herein by reference. Other examples of pattern transfer processes are described in Chapters 12 and 13 of “Semiconductor Lithography, Principles, Practices, and Materials” by Wayne Moreau, Plenum Press, (1988), the disclosure of which is incorporated herein by reference. It should be understood that the invention is not limited to any specific lithography technique or device structure.

The following examples are provided to illustrate the inventive resist composition and some advantages in using the same.

### EXAMPLE 1

Hydrolysis of 2-acetoxy-3,3,3-trifluoropropyl trichlorosilane and 4-acetoxyphenylethyl trichlorosilane monomer mixture (70/30 mole ratio of monomers).

2-Acetoxy-3,3,3-trifluoropropyl trichlorosilane (30 grams, 0.104 mole) and 4-acetoxyphenylethyl trichlorosilane (13.27 grams, 0.0446 mole) monomer mixture in tetrahydrofuran (THF, 40 grams) were added dropwise into a cold solution (ice/water bath) of diethylamine (32.6 grams, 0.149 mole) and water (40 grams). The mixture was stirred at room temperature overnight. The mixture was then diluted with ether (25 ml) and the organic phase separated. The water phase was extracted with ether (2 times, 60 ml first, then 25 ml) and the organic solutions were combined. The combined organic solution was washed with brine (2 times, 50 ml each) and dried over anhydrous magnesium sulfate overnight. The solvent was removed the next day by rotary evaporation.

### EXAMPLE 2

Synthesis of poly (2-acetoxy-3,3,3-trifluoropropylsilsesquioxane-co-4-acetoxyphenylethylsilsesquioxane) (70/30 mole ratio of monomers).

The product from EXAMPLE 1 was dissolved in toluene (40 grams) and placed in a round bottom flask equipped with a Dean-Stark water separator (to remove the water produced during condensation-reaction) and a water condenser. Potassium hydroxide (˜70 mg) was added to this solution and the resulting mixture was heated at 135° C. for 18 hours. Afterwards, the solution was filtered through a frit funnel and the solvent was removed in a rotary evaporator.

### EXAMPLE 3

Synthesis of poly (2-hydroxy-3,3,3-trifluoropropylsilsesquioxane-co-4-hydroxyphenylethylsilsesquioxane) (70/30 mole ratio of monomers).

Methanol (35 ml), tetrahydrofuran (50 ml) and ammonium hydroxide (30% solution in water, 43 ml) were added to the polymer product of EXAMPLE 2 and the resultant solution heated to mild reflux at 70° C. overnight. The solution was then cooled to room temperature and added dropwise into a mixture of water (1000 ml) and glacial acetic acid (30 ml). The resultant precipitated polymer (coagulated) was separated by decantation, rinsed with water (2 times, 300 ml each), and dried in a vacuum oven at 65° C. for short time. The polymer was re-dissolved in acetone and re-precipitated in mixture of water and acetic acid mixture and filtered with frit funnel and washed with water the same way as described above. The collected polymer was dried in a vacuum oven at 65° C. for 24 hours. Yield: ˜11 grams, Mw 7,230, and PD 1.15.

### EXAMPLE 4

Synthesis of methoxycyclohexene (MOCH) protected poly(2-hydroxy-3,3,3-trifluoropropylsilsesquioxane-co-4-hydroxyphenylethylsilsesquioxane) (70/30 mole ratio of monomers).

1.5 gram of poly(2-hydroxy-3,3,3-trifluoropropylsilsesquioxane-co-4-hydroxyphenylethylsilsesquioxane) synthesized in EXAMPLE 3 was dissolved in PGMEA to form 10 grams of 15 wt. % solution. The solution was added with approximately 10 mg of oxalic acid under stirring with magnetic bar. After the acid was dissolved, 0.96 grams of 1-methoxycyclohexene was added to the solution, and the reaction was carried out at room temperature with stirring overnight. The reaction was then quenched with 1 gram of basic active aluminum oxide. The protection levels of 3% out of the 70% on the fluorocarbinol groups (protected vs. unprotected, around 3/67) and 15% out of the 30% on the phenol groups (protected vs. unprotected, around 15/15) were determined by C¹³NMR.

### EXAMPLE 5

### Resists Formulations.

Resist formulations were obtained by mixing MOCH protected poly(2-hydroxy-3,3,3-trifluoropropylsilsesquioxane-co-4-hydroxyphenylethylsilsesquioxane) (70/30 mole ratio of monomers) (from EXAMPLE 4) with 1.12 wt. % (relative to the polymer) tetrabutyl ammonium hydroxide (TBAH) and 5.6 wt. % triphenylsulfonium perfluorobutanesulfonate (TPS PFBUS) and approximately 1000 ppm of FLUORAD™ FC-430® surfactant (available from 3M Company) in PGMEA solvent. The total solid weight content in the solution was about 3.5 wt. % for Resist A and it was about 2.5 wt % for Resist B.

### EXAMPLE 6

### Lithographic Evaluations.

Resist A obtained from EXAMPLE 5 was spin coated with 3500 rpm on HMDS primed wafers. The films were baked on a hot plate at 90° C. for 1 minute to obtain thicknesses around 40 nm range. The exposures were performed on a 100 kV Leica exposure system. After exposure, the resist was either baked at 100° C. for 60 s or allowed to sit in the regular lab environment for 30 minutes without PEB before being developed with 0.263 N TMAH for 30 s. High resolution of 30 nm l/s images were obtained on both baked and without baked wafers at around 99-106 μC/cm² (no proximity correction). Resist B obtained from EXAMPLE 5 was spin coated with 400 rpm on HMDS primed wafers. The films were baked on a hot plate at 90° C. for 1 minute to obtain thicknesses around 28 nm range. The exposures were performed on a 100 kV Leica exposure system. After exposure, the resist was either baked at 100° C. for 60 s or allowed to sit in the regular lab environment for 30 minutes without PEB before being developed with 0.263 N TMAH for 20 s. High resolution of 30 nm l/s images were obtained on both baked and without baked wafers at around 97-121 μC/cm². High resolution of 20 nm l/s images was obtained on no PEB wafer at around 121 μC/cm², while the wafer with 100° C./60 s PEB did not provide clean 20 nm l/s images.

While the present invention has been particularly shown and described with respect to preferred embodiments thereof, it will be understood by those skilled in the art that the foregoing and other changes in forms and details may be made without departing from the spirit and scope of the invention. It is therefore intended that the present invention not be limited to the exact forms and details described and illustrated but fall within the scope of the appended claims.

Having thus described our invention in detail, what we claim as new and desire to secure by the Letters Patent is:

1. A resist composition comprising a polymer and a photoacid generator, the polymer comprising pendant polar moieties, pendant fluoroalcohol moieties, and a backbone containing SiO moieties, wherein at least a portion of said pedant polar moieties are protected with acid labile moieties having a low activation energy.

2. The resist composition of claim 1, wherein some, but not all, of the pendant fluoroalcohol moieties are protected with acid labile moieties having a low activation energy.

3. The resist composition of claim 1, wherein the backbone containing SiO moieties is a silsesquioxane backbone.

4. The resist composition of claim 1, wherein each of the pendant polar moieties comprises one or more hydroxyl or carboxylate groups.

5. The resist composition of claim 1, wherein each of the pendant polar moieties comprises phenolic groups.

6. The resist composition of claim 1, wherein each of the pendant fluoroalcohol moieties comprises the following structure: 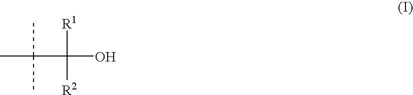
wherein R¹ is hydrogen, or a semi- or per-fluorinated alkyl group having 1 to 6 carbon atoms; and R² is a semi- or per-fluorinated alkyl group having 1 to 6 carbon atoms.

7. The resist composition of claim 6, wherein R¹ is hydrogen, trifluoromethyl, difluoromethyl, or fluoromethyl; and R² is trifluoromethyl, difluoromethyl, or fluoromethyl.

8. The resist composition of claim 1, wherein the acid labile moieties having the low activation energy are selected from the group consisting of acetals, ketals, and orthoesters.

9. The resist composition of claim 1, wherein the acid labile moieties having the low activation energy are cyclic aliphatic ketals.

10. The resist composition of claim 9, wherein the cyclic aliphatic ketals are selected from the group consisting of methoxycyclopropanyl, ethoxycyclopropanyl, butoxycyclohexanyl, methoxycyclobutanyl, ethoxycyclobutanyl, methoxycyclopentanyl, ethoxycyclopentanyl, methoxycyclohexanyl, ethoxycyclohexanyl, propoxycyclohexanyl, methoxycycloheptanyl, methoxycyclooctanyl, and methoxyadamantyl.

11. The resist composition of claim 1, wherein the photoacid generator is a triaryl sulfonium perfluoroalkylsulfonate.

12. The resist composition of claim 1, wherein the pendant polar moieties and the pendant fluoroalcohol moieties are in a ratio from about 9:1 to about 1:9.

13. The resist composition of claim 1, wherein about 10 to about 100 mol % of the pendant polar moieties are protected with the acid labile moieties having the low activation energy.

14. The resist composition of claim 2, wherein about 1 to about 99 mol % of the pendant fluoroalcohol moieties are protected with the acid labile moieties having the low activation energy.

15. The resist composition of claim 1, wherein the polymer has a weight average molecular weight ranging from about 1K Daltons to about 200K Daltons.

16. The resist composition of claim 1, wherein the polymer comprises a combination of monomer units having the following structures: 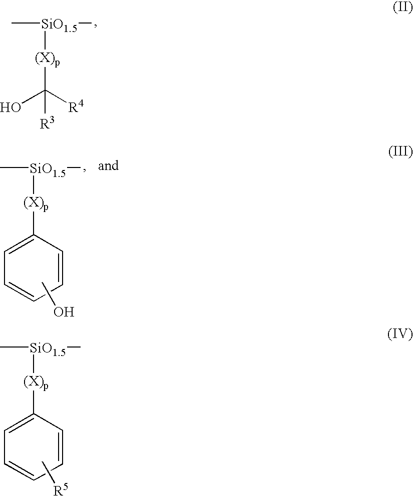
wherein X is a linear or branched alkylene group having 1 to 6 carbon atoms; p is an integer of 0 or 1; R³ is hydrogen, or a semi- or per-fluorinated alkyl group having 1 to 6 carbon atoms; R⁴ is a semi- or per-fluorinated alkyl group having 1 to 6 carbon atoms; and R⁵ is a cyclic aliphatic ketal.

17. The resist composition of claim 16, wherein the polymer further comprises a monomer unit having the following structure: 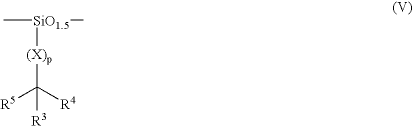
wherein X is a linear or branched alkylene group having 1 to 6 carbon atoms; p is an integer of 0 or 1; R³ is hydrogen, or a semi- or per-fluorinated alkyl group having 1 to 6 carbon atoms; R⁴ is a semi- or per-fluorinated alkyl group having 1 to 6 carbon atoms; and R⁵ is a cyclic aliphatic ketal.

18. A method of forming a patterned structure on a substrate, said method comprising:
applying a resist composition to a substrate to form a resist layer on the substrate, the resist composition comprising a polymer having pendant polar moieties, pendant fluoroalcohol moieties, and a backbone containing SiO moieties, wherein at least a portion of said polar moieties are protected with acid labile moieties having a low activation energy;
patternwise exposing the resist layer to an imaging radiation;
developing a patterned resist structure in the exposed resist layer; and
transferring the pattern in the patterned resist structure to the substrate.

19. The method of claim 18, prior to applying the resist composition to the substrate to form the resist layer, further comprising forming a planarizing layer over the substrate.

20. The method of claim 18, wherein the pattern in the patterned resist structure is transferred to the substrate by reactive ion etching, plasma etching, ion implanting, deposition, electroplating or wet etching.
